(19) United States
(12) Patent Application Publication
(10) Pub. No.: US 2009/0077022 A1
(43) Pub. Date: Mar. 19, 2009

(54) SPATIAL AGGREGATOR SYSTEM FOR PROVIDING INFORMATION

(76) Inventor: Adrian Cuthbert, Cambridge (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/577,765

(22) PCT Filed: Oct. 18, 2005
(86) PCT No.: PCT/GB05/04011

§ 371 Date: Dec. 2, 2008

(30) Foreign Application Priority Data
Oct. 21, 2004 (GB) 0423315.1

(51) Int. Cl. G06F 17/30

(52) U.S. Cl. 707/3; 707/E17.014

(57) ABSTRACT

An information providing system comprises means for reading information feeds from one or more sources which are designed to be machine readable rather than user readable, one or more of said feeds having content expressed as a number of entries where each entry incorporates a spatial reference, means for assessing a user's interest in order to match a user's interest to content obtained from said feeds and means for providing to a user content from said spatially referenced feeds, whereby the content closely matches the user's spatial interest.

### FIELD OF THE INVENTION

The invention relates to information providing systems. These systems may have a wide variety of applications from desktop to mobile unit applications.

Whilst in the following specification a mobile phone is used to describe a particular application of the invention, the invention also relates to fixed and mobile receiving units of all kinds including desktop computers, laptops, PDAs (personal digital assistants such as Palm Pilots (registered trade mark)) or the like, as well as vehicles or boats which are then mobile receiving units.

### BACKGROUND TO THE INVENTION AND PRIOR ART KNOWN TO THE APPLICANT(S)

The invention (sometimes referred to as a ‘spatial aggregator’) makes it easy for people (‘publishers’) to publish information relating to real-world locations and for other people (‘users’) to discover information about a specified locality. Information relating to a real-world location is sometimes referred to as spatial information. The invention plays a similar role to ‘search engines’ such as Google (registered trade mark) and Yahoo (registered trade mark). Consequently the closest prior art may be found in search engines.

Search engines build an index of the web by ‘crawling’ web sites and retrieving and indexing individual web pages. The languages used to describe web pages (e.g. HTML) carry textual content together with mark-up which describes how the content should be presented. This allows different parts of a page to be identified and, if required, treated differently. For example it would be possible to identify the title of a web page and give words appearing in a page title more ‘importance’ than words appearing in the body of the page.

The crawling process itself involves following ‘links’ found on a web page to find new web pages. However it is difficult for the crawling process to retrieve web pages which, under normal browsing circumstances, would be generated in response to user input. For example it may be necessary for a user to type in the name of a railway station to gain access to the web page showing the timetable for the specified station. Thus, without knowledge of the correct railway station names, it is not possible for the crawling process to find the timetable pages.

Search engines may return spatial information in response to a user who includes a geographical reference in their search query, such as the worn ‘Brazil’ in the query ‘Brazil nuts’. Conceptually, the search engine finds all web pages that relate to the word ‘Brazil’ and all those relating to the word ‘nuts’ and then orders them according to some function of their match with the query and global criteria, such as the relative importance of the web page on the web as a whole. This approach does not require a search engine to understand that the word ‘Brazil’ relates to a specific locality any more than the word ‘nuts’ does.

More recently search engines have included options for ‘local’ search. In local search part of the search query is expected to include words that relate specifically to location. Indeed in most incarnations the user is presented with two text boxes to fill out denoted ‘What’ and ‘Where’. To support local search, it is necessary to extract more information from a web page when it is originally ‘crawled’. A search engine must first determine if a spatial reference is present in a web page and if so what location it refers to. It must do this based on content and mark-up that has been written primarily for presentation purposes. Unlike the title of a page, spatial references in the body of the page cannot be easily identified.

The invention differs from this ‘traditional’ form of local search in the technical system employed to gather the spatial information.

### SUMMARY OF THE INVENTION

In its broadest independent aspect, the invention provides an information providing system, comprising means for reading information feeds from one or more sources which are designed to be machine readable rather than user readable, one or more of said feeds having content expressed as a number of entries where each entry incorporates a spatial reference, means for assessing a user's interest in order to match a user's interest to content obtained from said feeds and means for providing to a user content from said spatially referenced feeds, whereby the content closely matches the user's spatial interest.

In one aspect, the inventive system comprises means for reading feeds specifically designed to be aggregated by machine. In a subsidiary aspect, such feeds are available from modern personal publishing tools, sometimes referred to as blog authoring tools, which generate both a human readable web-site and a machine readable feed.

Languages used to describe web pages (e.g. HTML) carry textual content together with mark-up which describes how the content should be presented. Languages used to implement feeds (e.g. RSS and Atom) carry textual content together with mark-up which describes what the content means.

The inventive system allows both the publisher and the user to use a range of types of spatial reference to identify locations and specify localities. This optionally includes specifying a location/locality using coordinates within a specified coordinate reference system. It also optionally includes specifying a location/locality using an address. The ability to work with multiple types of spatial reference minimises the geospatial expertise required by the publisher, making it easier to publish spatial information. It also minimises the geospatial expertise required by users making spatial information more accessible.

In one aspect, the inventive system may convert all published information and queries into a common coordinate reference system using the techniques of geocoding and reverse-geocoding where necessary.

The combination of features defined in the invention's broadest independent aspect is particularly inventive because it allows a user to receive immediately relevant information to his/her particular interest. For example, if a user sends a query to the system of the following kind: “What eating places are in close proximity?”, the system would send information specific to the location of the user without sending all the addresses in say Cambridge which would be impossible for a user to assess or requiring the user to know what post code/street he/she is in at the time of querying. The information provided is therefore precisely spatially relevant and straight forward for a user to assess. This system has particular benefits for mobile phone applications but may also be advantageous for desktop applications.

The invention is particularly advantageous because in one aspect it gathers spatial information by reading feeds which includes mark-up that directly identifies an associated location. That is the publisher has explicitly specified an association with a location. Furthermore the publisher has identified the location using a spatial reference with a well-defined interpretation. This is in contrast to traditional local search where the search engine must first determine if a spatial reference is present in a page and if so what location it refers to. It must do this based on content and mark-up that has been written primarily for presentation purposes. As a consequence the results of the invention are less prone to error.

Furthermore, through the use of a feed, the publisher is able to describe content that may not be accessible to standard ‘web-crawling’ techniques used by traditional search engines. For example a publisher can provide information about deep-linked resources that would ordinarily require a user to supply some input before gaining access.

Furthermore, through the use of standard technologies related to the publishing of a feed, the publisher is able to notify the inventive system (or have the inventive system discover) new content in a timely manner. This means that feeds can deliver information about short-lived content that would normally be out of date before it became accessible via a traditional search engine.

In a subsidiary aspect in accordance with the invention's broadest independent aspect, the system is set to regularly poll feeds to build up a database of spatially referenced content. This would be particularly advantageous as it will allow a user to readily obtain relevant data from sources of interest and relevant to the spatial enquiries of a user. This would also allow current information to be readily obtainable by the user. The database may be interrogated without further access to the original information source. This may be particularly useful when connections to the source are not available in real time for any reason.

In a further subsidiary aspect, the system is configured to respond to a user's interest when it includes a spatial reference such as a postcode and/or keywords and/or spatial coordinates.

In a further subsidiary aspect, the system is configured to respond to a user's interest when it includes a time and/or date of interest.

In a further subsidiary aspect, the system is configured to respond to a user's interest when it includes personal information relating to the user, such as a profile representing their interests and/or their interest in specific feeds and/or semantically tagged spatial references for locations such as “home” and “office”.

In a further subsidiary aspect, the system assesses a multiplicity of spatial references such as post codes and/or keywords and/or spatial coordinates contained in the feeds' entries. This approach avoids the provider to necessarily adopt an industry wide standard. The system will thus be able to assess a variety of feed types.

In a further subsidiary aspect, the provider of the feeds assigns a time-based spatial reference to entries contained within the feeds. This allows more relevant information to be identified rapidly.

In a further subsidiary aspect, the provider of the feeds assigns classification information to entries contained within the feeds.

In a further subsidiary aspect, the provider of the feeds assigns labelling information and/or information relating to a graphic representation (for example ‘icons’) such that the entry can be represented in a human-readable form either textually on a page or graphically in an image.

In a further subsidiary aspect, the source provider of the feeds assigns a deep-link to entries contained within the feeds so that the human-readable form of an entry can be ‘linked’ to further information. This allows further information to be retrieved about said entry using standard Internet-based techniques.

In a further subsidiary aspect, means are provided to store the information in categories and record previously accessed information, whereby the system selects information according to previously recorded interests. This also allows information of greater relevance to be provided to a user, particularly when a user information request is broad such as “Restaurants in Soho”.

In a further subsidiary aspect, the system is embodied in a mobile guidance system comprising a mobile receiving unit for receiving and displaying location indications; processing means located remotely from said mobile receiving unit; means allowing remote communication between said unit and said processing means and means for determining the user's specific spatial position; characterised in that said processing means assess determined user specific spatial positions with user's interest criteria in order to provide the user with access to a display of location indications and user interest information.

This system has a number of advantages such as, if a mobile user is interested in receiving up to date train times for a given destination, the system allows a map of the location of a train station and the user's interest criteria to be displayed concurrently. The user may for example not be interested in MacDonalds, Supermarkets or other locations close by on his/her way to the train station. The display of carefully selected information in this manner minimises the information to be displayed in a user specific manner in order to improve the display particularly on small-scale mobile phone units.

In a further subsidiary aspect, the communication between the unit and the processing means employs means for updating in real time both the user interest information and location indications displayed. This would for example allow a correct minimal train timetable to be displayed alongside the map. This could take into account of train delays etc allowing users for example to step inside an out-of-station coffee shop without actually reaching the station if a train delay is signalled.

In a further subsidiary aspect, the processing means store the information in categories and record previously accessed information, whereby the system selects the display according to previously recorded interests. This allows specific tailoring of the information sent for display both minimising the display of information which would not be of interest to the user and therefore maximising clarity of displays and their overall usefulness.

In a further subsidiary aspect, means are provided to allow the user to block certain displays.

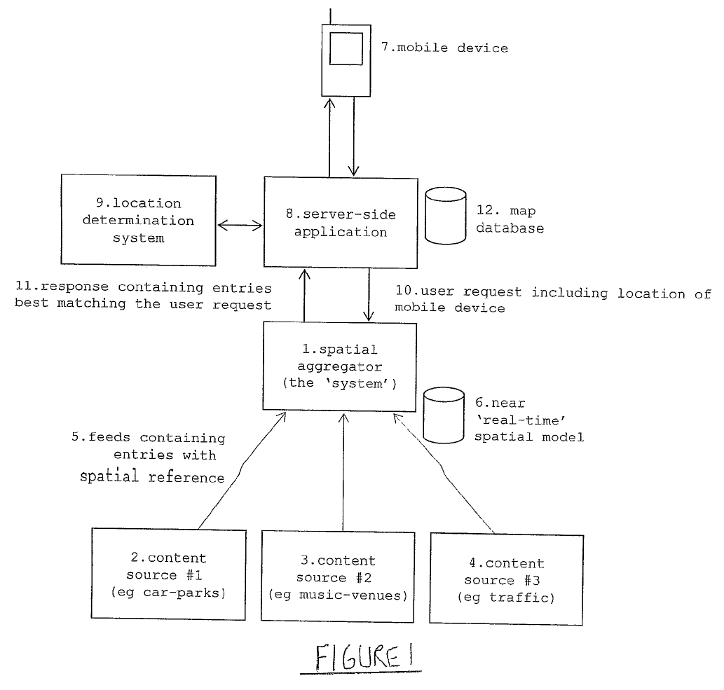

### DESCRIPTION OF FIG. 1

FIG. 1 shows a flow diagram of an arrangement using a spatial aggregator.

The spatial aggregator 1 polls content sources 2, 3 and 4 and gets, by way of response, feeds containing entries with spatial references 5. The spatial aggregator uses these to populate a spatial model 6. The user makes a request from their mobile device 7 to a server-side application 8. This uses a location determination system 9 to get the approximate location of the user. The application then makes a request on behalf of the user (the user's request 10) to the spatial aggregator 1 containing the user's approximate location. The spatial aggregator determines which entries in the spatial model 6 best match the user's request and sends them back in a response 11 to the server-side application. The server-side application then renders the information in the response into a page. In conjunction with the map database 12 it constructs a map image. The page and map images are used in the response to the mobile device 7.

According to well established patent practice, FIG. 1 is one possible illustration of how an inventive spatial aggregator 1 might be used (The scope of the invention being defined in the Claims that follow this description). For example, the user request 10 may originate from a desktop application or a Java application resident on a mobile device (rather than a combination of mobile device 7 and server-side application 8) using a location obtained by looking up an address rather than from a location determination system 9.

In the embodiment of FIG. 1, a user employs a mobile phone having a mobile receiving unit. When a user activates the system a user locator which may use any known spatial position determining technology identifies the approximate mobile phone position. The position of the user is then matched with spatially referenced content obtained by the aggregator in order to furnish the user with specific spatial content.

The aggregator will poll information feeds from a number of sources. These feeds deliver spatially referenced content as a set of entries in a machine readable format such as XML which are not end user readable for the purposes of this description. Requests may include information about when the feed was last polled. The system can be configured to handle feeds that return only incremental changes, or feeds that indicate there have been no changes since the specified polling time.

An entry in a feed contains information about something that has an associated location in the real-world. For example a venue such as the ‘Albert Hall’ has an associated location. Similarly an event such as ‘2004 Proms’ has an associated location and an associated ‘period of time’. The location is expressed as a spatial reference. Typically the information also includes some or all of the following: a human readable label, a brief description and one or more ‘deep’ links that allows more information to be retrieved using standard Internet technologies. The following example shows a possible feed response with a single entry:

<feed>

<entry>

<label>Gwen John and Augustus John</label>
<link>http://www.tate.org.uk/britain/exhibitions/john/</link>
<description> This is the first major exhibition to focus on the

work of sibling artists Gwen and Augustus John.</description>

<spatial_reference>

<post code>SW1 P 4RG</postcode>

</spatial_reference>

</entry>

</feed>

A spatial reference may define a location with high precision (for example a building number and postcode can identify an individual building in the UK) or it may define a location with extent (for example a postcode can be approximated by a point and an associated radius).

Alternate mechanisms for supplying a spatial reference may be used. For example the spatial_reference tag could be used to hold a location specified using geographical coordinates in a default coordinate reference system:

<spatial_reference>

<qeo:lat>51.4909</geo:lat>
<geo:long>−0.1272</geo:long>

</spatial_reference>

The system may be configured to recognise a number of types of spatial reference and does not rely on the presence of a spatial_reference tag. The system resolves all spatial references into a common spatial model that allows all content to be queried spatially.

Entries may also include information about what the entry represents (for example a classification such as ‘car_park’, ‘train_station’, ‘music_venue’ etc, and/or a set of attributes which combine a name and value where both can be enumerated such as ‘category:restaurant’, ‘cuisine:turkish’, ‘tag:kebab’, ‘tag:meze’ etc, and/or a flag indicating whether the entry is ‘sponsored’) and information about how the entry should be rendered. For example, if the entry is to be represented on a map, the entry may include information about what ‘icon’ to use to represent it. Further-more this information may include a flag indicating if the ‘icon’ is dynamic or not. Dynamic icons could be fetched at the time the map is being constructed to ensure the most ‘up-to-date’ result. Similarly, if the entry is to be represented textually, the entry may include a descriptive fragment, which could be flagged as being a ‘dynamic fragment’.

For example consider a fictitious third-party that provides information about car-parks, say Parking4Us. They could provide a feed that gave the locations of a set of car-parks. Each entry would include a unique Internet reference to the ‘dynamic icon’ to be used to represent that particular car-park. At the time the map is being constructed the icons for the car-parks on the map would be retrieved from the Parking4Us service. These could provide a visual indicator of whether the car-parks are currently full or not.

The system can be configured to poll different feeds at different frequencies. For example a feed containing very dynamic data (for example the location of traffic delays) might be polled every ten minutes. A feed containing very static data (for example what plays are showing at which theatres) might be polled every week. A spatial reference may also include information which defines over what period in time the entry can be considered valid. These two approaches allow the system to build and maintain a near ‘real-time’ spatial model.

The system responds to requests by returning a set of entries that closely match the user's interest. The user's request includes a spatial reference which is resolved into the same spatial model used when reading the information feeds. The spatial reference need not represent the current location of the user. For example a request originating from a user using a desktop web-browser may include a spatial reference representing a location they are planning on visiting at a later time; whereas a request originating from a user using a mobile device may include a spatial reference representing the location of the mobile device as determined by a location determination system such as a cell-id.

From FIG. 1, the response from the system 11 is rendered into a suitable form for display by the server-side application 8 for viewing by the user with the mobile device 7. For example the user may see a page listing nearby music venues and cinemas. Each entry in the list might include a link that, when followed, would provide further information about the selected entry. Alternatively the page might include a map image that displays the locations of the music venues and cinemas as icons. Furthermore, the page may include links for entries that cannot be easily represented on the map, for example entries which have a large geographical extent such as the coverage of a radio station.

The user's request may also include a date and time. This need riot be the same as the date and time at which the request is being made. Thus a user may make a request about some time and date in the future and receive information about plays that are going to be performed at that time. The server-side application 8 is responsible for constructing the user request 10 and thus needs to provide the user with an interface to select a preferred date and time, although it may default to supplying the current date and time.

The user's request may also include information about the user's profile which allows the system to better match content to the user's interest. This information needs to be used in conjunction with the information about the entries, for example the classification of an entry.

The user's request may also include information related to information feeds. For example, the request many indicate that a user does not want to see any content from a particular feed (a ‘blacklist’), or it may indicate that a user is subscribed to premium content from particular feeds, or it may indicate that the user only wishes to see content from selected feeds. This mechanism can also be used to allow user requests to inform the system about new feeds that it should read. If the system is configured to recognise certain feeds as delivering only premium content, then such content will only be included in responses to user requests which indicate the user is subscribed to that content. It should be noted that ‘dynamic icons’ or ‘dynamic fragments’ may produce different results for subscribed and unsubscribed users. Alternatively a source of feeds may publish two feeds, one with premium content and one with non-premium content.

Alternatively the system may maintain information related to information feeds on a per-user basis. Thus the user's request need only include a user-identifier.

The system may be configured to return specific mixes of types of entries in its responses. For example the system could be configured to return no more than a certain number of ‘car-parks’ per request. Alternatively it might be configured to return no-more than one ‘sponsored’ entry per request.

From FIG. 1, the user accesses the system 1 via a mobile device 7 and a server-side application 8. The application can be written to provide a near ‘real-time’ experience by repeatedly making the same user request 10 on behalf of the user to the system. If such requests indicate a time of a previous, identical request, the system need only return entries that have altered since the previous request. This includes new entries which have been added, entries which have changed and entries which have been removed.

User requests to the system may include personalised information such as a set of locations which are known to the user. Such locations would include a spatial reference (such as a keyword and/or a postcode and/or spatial coordinates) and some form of semantic identifier (such as a keyword drawn from a restricted set such as ‘home’, ‘office’ etc). This information allows the system to better match content to a user's likely interest. This information may be supplied by the server-side application. Alternatively the system may maintain information related to locations on a per-user basis. Thus, the user's request need only include a user-identifier.

1-15. (canceled)

16. An information providing system, comprising
means for reading syndication feeds from at least one source; at least one of said feeds having content expressed as a number of entries where each entry incorporates a spatial reference;
means for populating a spatial model from such spatially referenced feed entries; means for assessing a user's interest in order to match a user's interest to content held in said spatial model; and
means for providing to a user content from said spatial model; whereby the content closely matches the user's spatial interest.

17. A system according to claim 16, further comprising means to regularly poll feeds to build up a database of spatially referenced content.

18. A system according to claim 16, further comprising means for responding to a user's interest when it includes a spatial reference.

19. A system according to claim 16, further comprising means for responding to a user's interest when it includes any one of: a time and a date of interest.

20. A system according to claim 16, further comprising means for responding to a user's interest when it includes personal information relating to the user, such as any one of: a profile representing their interests, their interest in specific feeds, and semantically tagged spatial references for locations such as ‘home’ and ‘office’.

21. A system according to claim 16, wherein the system assesses a multiplicity of spatial references such as any one of: post codes, keywords, and spatial coordinates contained in the feeds' entries.

22. A system according to claim 16, wherein the provider of the feeds assigns a time-based spatial reference to entries contained within the feeds.

23. A system according to claim 16, wherein the provider of the feeds assigns classification information to entries contained within the feeds.

24. A system according to claim 16, wherein the provider of the feeds assigns one of labelling information and information relating to a graphic representation (for example ‘icons’) such that the entry can be represented in a human-readable form either textually on a page or graphically in an image.

25. A system according to claim 16, wherein the source provider of the feeds assigns a deep-link to entries contained within the feeds so that the human-readable form of an entry can be ‘linked’ to further information.

26. A system according to claim 16, wherein means are provided to store the information in one of: categories, associated tags, and associated attributes; and record previously accessed information; whereby the system selects information according to previously recorded interests.

27. A system according to claim 16, operating in conjunction with a mobile guidance system comprising a mobile receiving unit for receiving and displaying location indications; processing means located remotely from said mobile receiving unit; means allowing remote communication between said unit and said processing means and means for determining the user's specific spatial position; wherein said processing means assesses determined user specific spatial position with user's interest criteria in order to provide the user with access to a display of location indications and user interest information.

28. A system according to claim 27, wherein the communication between the unit and the processing means employ means for updating in real time both user interest information and location indications displayed.

29. A system according to claim 27, wherein means are provided to allow the user to block certain displays.
